(19) United States
(12) Patent Application Publication
(10) Pub. No.: US 2015/0302407 A1
(43) Pub. Date: Oct. 22, 2015

(54) A METHOD AND A SYSTEM FOR AUTHORIZING PAYMENTS

(71) Applicant: MASSPAY SP. Z.O.O., Jaroszowa Wola (PL)

(72) Inventor: Henryk KULAKOWSKI, Jaroszowa Wola (PL)

(21) Appl. No.: 14/442,069

(22) PCT Filed: Nov. 12, 2013
(86) PCT No.: PCT/PL2013/000143

§ 371 Date: May 11, 2015

(30) Foreign Application Priority Data
Nov. 12, 2012 (PL) P-401566

(51) Int. Cl. G06Q 20/40; G06Q 20/02; G06Q 20/32; G06Q 20/20

(52) U.S. Cl. CPC G06Q 20/40; G06Q 20/202; G06Q 20/023; G06Q 20/322

(57) ABSTRACT

A method and a system for authorizing payments, with the use, by a payer, of a mobile device MD and by a merchant a payment card terminal POS, identified by identifiers POS_ID1 and POS_ID2, such that payment card data and the transaction amount AMN are entered into terminal POS, and, along with the terminal identifier POS_ID1, are sent to the clearing center ACH. The clearing center ACH, basing on received data, generates an authorization request to the payment provider PSP. Simultaneously, the payer enters, on the mobile device MD, the terminal identifier POS_ID2 that along with the payer identifier U_ID is sent to the payment provider PSP, which, in response, sends back the actual information about the transaction to be accepted by the payer on his/her mobile device MD. After completing the information from the merchant and from the payer, the payment provider PSP sends an authorization request to the financial institution FI hosting the payer's funds account.

The invention relates to a method and a system for authorizing payments using devices of mobile telecommunications.

Solutions are known in the field of payments by payment cards via terminals, as well as trials of using those terminals for payments via mobile devices. Unfortunately, the integration of mobile payments with terminals for payment cards usually requires modifying such a terminal by writing special software dedicated for it. Each change of the software in the card terminal requires an expensive process of its certification by the biggest payment providers, like Visa or MasterCard. Also, an exchange of software is a laborious and expensive process.

The object of this invention is using a modified infrastructure for supporting payment cards for purposes of servicing payments with the use of mobile devices.

According to a first embodiment of the present invention, a method is provided for authorizing payments using a mobile device by a payer and a payment card terminal by a merchant, terminal identifiers being assigned to the terminal, and the payer identifier being assigned to the payer, the method comprising the steps of:

entering the amount of the transaction into the terminal;
entering payment card data into the terminal, the card being issued by a payment provider;
sending the terminal identifier, the payment card data, and the transaction amount from the terminal to the clearing center;
recognizing, by the clearing center, basing on the payment card data, that the transaction with the entered payment card is a transaction with the use of a mobile device;
sending, by the clearing center, an authorization request to the payment provider;
entering, on the mobile device, the terminal identifier and the payer identifier;
sending the terminal identifier and the payer identifier from the mobile device to the payment provider;
sending, by the payment provider to the mobile device, the currently possessed data related to the transaction;
accepting, by the payer, the transaction on the mobile device and sending the acceptance to the payment provider.

Preferably, the method for authorizing further comprises steps of sending an authorization request from the payment provider to a financial institution hosting the payer's funds account, and sending a transaction confirmation to the terminal.

According to the method according to the invention, the confirmation is sent also to the mobile device. Furthermore, the payer identifier is assigned to the mobile device or an information carrier attached to this device, and is read out automatically from the mobile device or the information carrier.

Preferably, in a method according to the invention, the authorization request to the financial institution is sent from the clearing center. Additionally, the authorization request may be sent from the clearing center to a financial institution co-operating with the payment provider, the financial institution forwarding the request to the payment provider.

According to a second embodiment of the present invention, a clearing system is provided for authorizing payment transactions, comprising: an IT system adapted for receiving an authorization request from a payment card terminal via a clearing center, and for receiving an authorization request from a mobile device, and for generating, basing on the requests from the terminal and mobile device, a final authorization request, and sending it to a financial institution. Preferably, the clearing system is adapted for receiving a message from the financial institution and sending the information contained thereto the terminal. Additionally the clearing system is adapted to sending the information contained in the message from the financial institution to the mobile device.

The invention is illustrated by the attached drawing, in which:

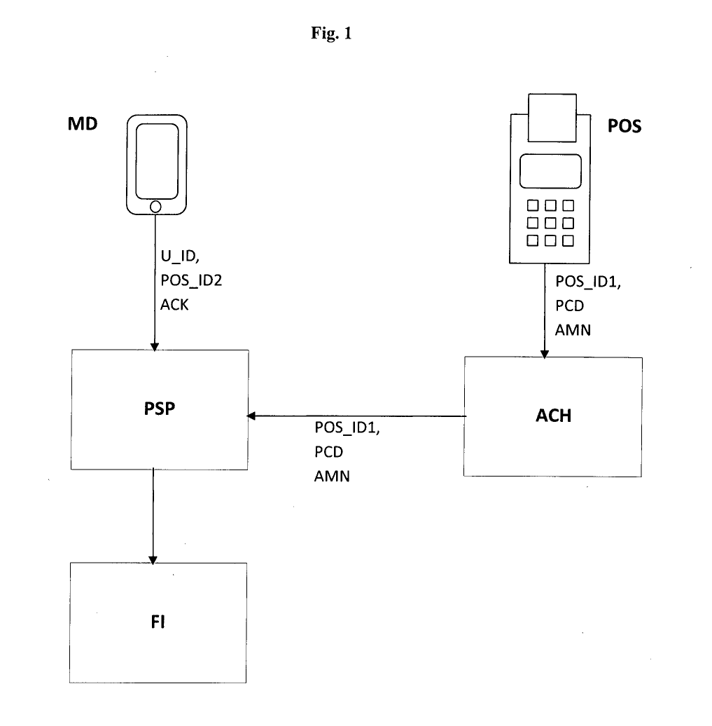

FIG. 1 shows a clearing system for authorizing payment transactions, in a first embodiment;

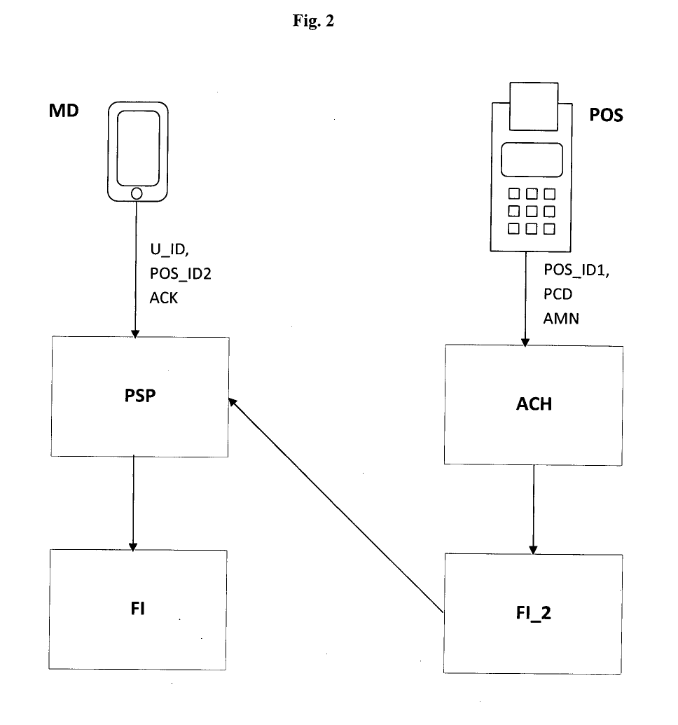

FIG. 2 shows a clearing system for authorizing payment transactions, in a second embodiment;

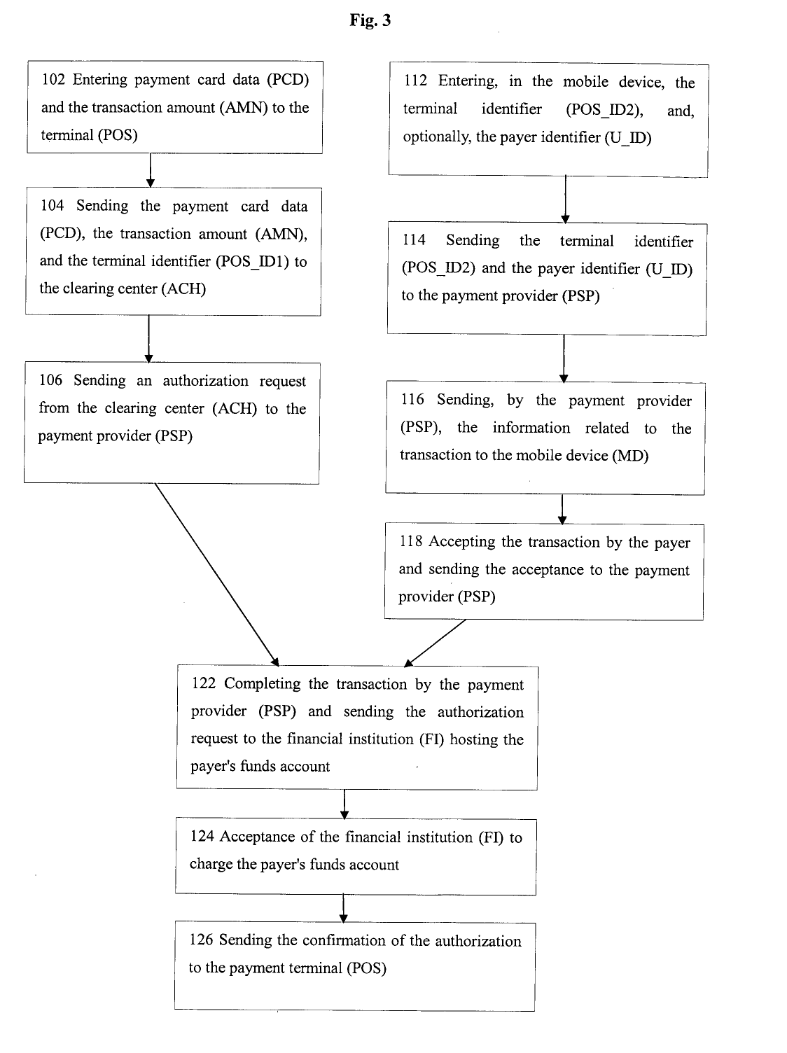

FIG. 3 shows a method for authorizing payments, in a first embodiment;

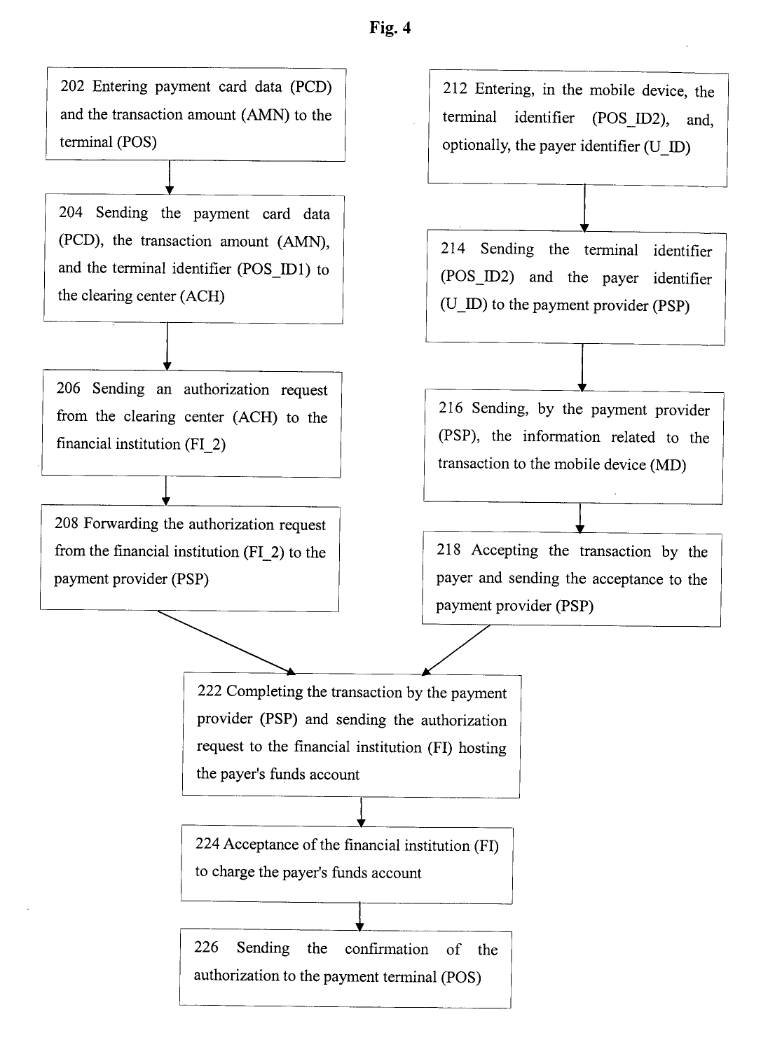

FIG. 4 shows a method for authorizing payments, in a second embodiment;

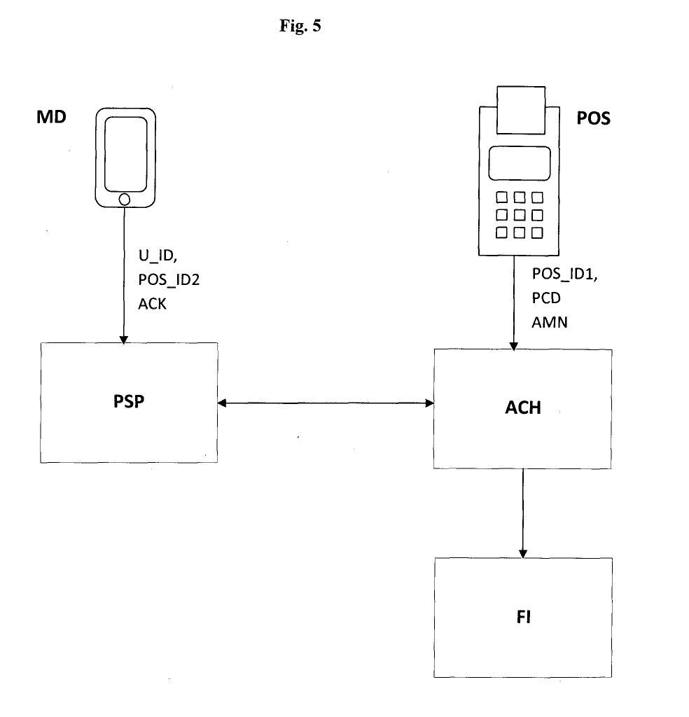

FIG. 5 illustrates a clearing system for authorizing payment transactions, in a third embodiment;

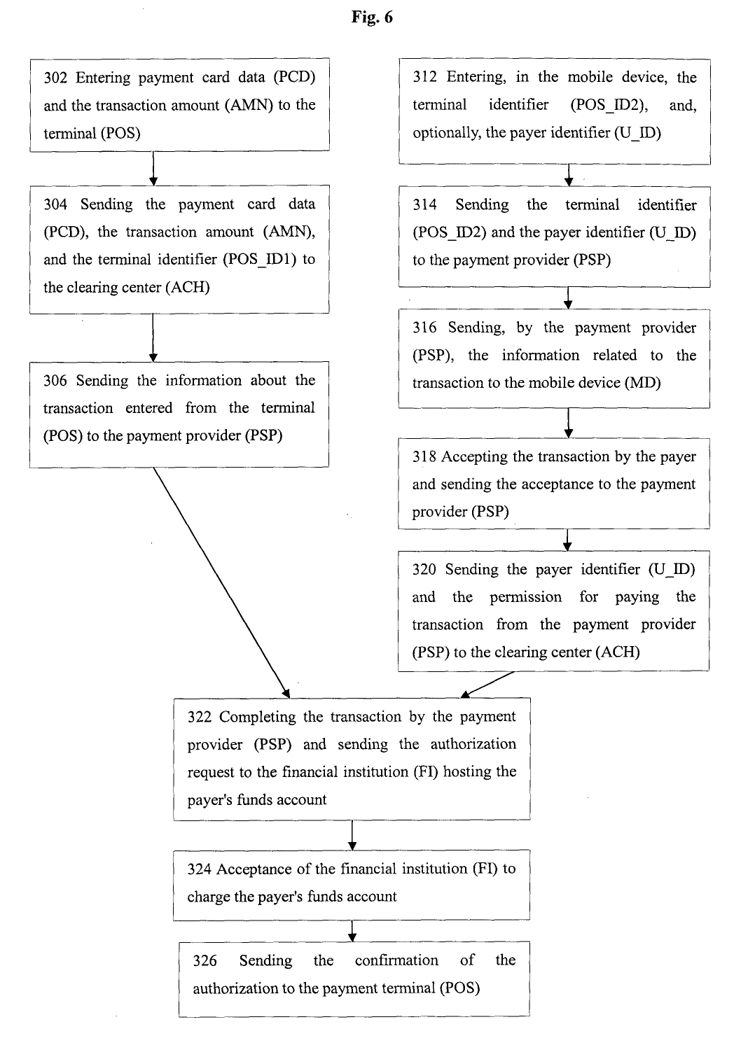

FIG. 6 shows a method for authorizing payments, in a third embodiment;

According to the invention, illustrated in FIGS. 1 and 3, similarly to a normal payment via a payment card, a merchant enters 102 on the terminal POS the transaction amount AMN and the payment card data PCD. The significant difference, in the contrary to a normal payment, is that the owner of the card used for the transaction is the merchant, not the payer. Additionally, the card is issued by a financial institution PSP. The transaction, being entered on the terminal POS, containing the payment card data PCD, the terminal identifier POS_ID1 and the transaction amount AMN, is sent 104 to the clearing center ACH, normally servicing all the payment card transactions from this terminal. Basing on the obtained data and the payment card number, the clearing center ACH sends 106 an authorization request to the payment provider PSP.

In the same time, using a mobile device MD, the payer enters thereon 112 the terminal identifier POS_ID2 presented him/her by the merchant. Also, the payer enters his/her payer identifier U_ID, unless it is permanently assigned to the mobile device or another information carrier, which is attached to the mobile device MD. The mobile device MD sends 114 the payer identifier U_ID along with the terminal identifier POS_ID2 to the payment provider PSP, which verifies whether it has information about the transaction with the terminal POS of the terminal identifiers POS_ID1 and POS_ID2. The information is sent 116 to the mobile device MD with a request for an acceptance by the payer. After obtaining the transaction acceptance 118 from the payer, the payment provider PSP sends 122 an authorization request, completing it with the information about the transaction from the clearing center ACH, to the financial institution FI hosting the payer's funds account, and after obtaining a permission 124 for charging this account, sends 126 a return message to the clearing center ACH, and then to the terminal POS. Preferably, the confirmation is sent also by the payment provider PSP to the mobile device MD. In the described case the sequence of steps 102-106 and 112-118 is independent on each other.

FIG. 4 shows a method for authorizing payments in a second embodiment, characterized in that the payment card used in the terminal POS is not issued by the payment provider PSP but, instead, it is issued by a collaborating with it financial institution FI_2. According to the present invention, illustrated in FIGS. 2 and 4, like in the case of a normal payment with a payment card, the merchant enters 202 on the terminal POS the transaction amount AMN and the payment card data PCD. The payment card is issued by the financial institution FI_2 collaborating with the payment provider PSP. The transaction entered onto the terminal POS, including the payment card data PCD, the terminal identifier POS_ID1, and the transaction amount AMN, is sent 204 to the clearing center ACH, normally servicing all the card transactions from the given terminal. Basing on the obtained data and the payment card number, the clearing center ACH sends 206 an authorization request to the financial institution FI_2 that is the issuer of the payment card, the financial institution FI_2 forwarding 208 this request to the payment provider PSP. Simultaneously, using the mobile device MD, the payer enters 212 onto the device, the terminal identifier POS_ID2 presented him/her by the merchant. Also, the payer enters his/her payer identifier U_ID, unless it is permanently assigned to the mobile device or another information carrier, which is attached to the mobile device MD. The mobile device MD sends 214 the payer identifier U_ID along with the terminal identifier POS_ID2 to the payment provider PSP, which verifies whether it has information about the transaction with the terminal POS of the terminal identifiers POS_ID1 and POS_ID2. The information is sent 216 to the mobile device MD with a request for an acceptance by the payer. After obtaining the transaction acceptance 218 from the payer, the payment institution PSP sends 222 an authorization request, completing it with the information about the transaction from the clearing center ACH, to the financial institution FI hosting the payer's funds account, and after obtaining a permission 224 for charging this account, sends 226 a return message to the terminal POS via the financial institution FI_2 and the clearing center ACH. Preferably, the confirmation is sent also by the payment provider PSP to the mobile device MD. In the described case the sequence of steps 202-208 and 212-218 is independent on each other.

Depending on what information about the transaction has the payment provider (what was the sequence of the steps 102-106 and 112-118 or 202-208 and 212-218), the payer, after communicating with it by his/her mobile device, receives the full or partial information about the transaction, this allowing him/her to perform the full authorization or only pre-authorization (when not knowing all the details).

FIG. 5 illustrates the clearing system for authorizing payment transactions in a third embodiment, wherein the authorization request from the card terminal POS is sent to the clearing center ACH of the payment cards, whereas the transaction data entered by the payer on the mobile device MD are sent to the payment provider PSP, while both sides, i.e., the payment provider PSP and the clearing center ACH are exchanging the information about the transaction, such that, finally, after completing it, the clearing center ACH sends a related authorization message to the financial institution FI hosting the payer's funds account.

FIG. 6 shows a method for authorizing payments in a third embodiment. According to the present invention, illustrated in FIGS. 5 and 6, like in the case of a normal payment with a payment card, the merchant 302 enters the transaction amount AMN and the payment card data PCD on the terminal POS. The significant difference, in the contrary to a normal payment, is that the owner of the card used for the transaction is the merchant, not the payer. The transaction entered onto the terminal POS, including the payment card data PCD, the terminal identifier POS_ID1, and the transaction amount AMN, is sent 304 do the clearing center ACH, normally servicing all the card transactions from the given terminal. Basing on the obtained data and the payment card number, the clearing center ACH sends 306 the information about the transaction to the payment institution PSP. Simultaneously, using the mobile device MD, the payer enters 312, onto the device, the terminal identifier POS_ID2 presented him/her by the merchant. Also, the payer enters his/her payer identifier U_ID, unless it is permanently assigned to the mobile device or another information carrier, which is attached to the mobile device MD. The mobile device MD sends 314 the payer identifier U_ID along with the terminal identifier POS_ID2 to the payment provider PSP, which verifies what information it has about the transaction with the terminal POS of the terminal identifiers POS_ID1 and POS_ID2. The information is sent 316 to the mobile device MD with a request for an acceptance by the payer. After obtaining the transaction acceptance 318 from the payer, the payment provider PSP sends the payer's acceptance along with his/her payer identifier U_ID to the clearing center ACH, which then completes the transaction and sends 322 an authorization request to the financial institution FI hosting the payer's funds account, and after obtaining a permission 324 for charging this account, sends 326 a return message to the terminal POS. Preferably, this confirmation is sent also by the payment provider PSP to the mobile device MD. In the above-described case, the sequence of the steps 302-306 and 312-318 is independent on each other.

The terminal identifier POS_ID2 of the terminal POS may be entered by the user manually or automatically: for example by using the near field communication technology or photocodes. Also, the payment card data may be entered to the terminal POS manually or by using electronic interfaces: for reading out a magnetic stripe, for reading out data from the contact pads of the card or in a contactless manner.

The above described solution makes it possible to support mobile transactions in an easy way by using existing terminals for payment cards. It is an enormously effective and cheap solution. The innovation in the above described solution is that the authorization of the transaction, in a payment terminal, is performed basing on the payment card owned by the merchant, not the payer, whereas the card identifier makes it possible to forward the authorization request appropriately and handle it not by the issuer of the card, but, instead, a payment provider providing the service of payments for mobile devices.

### EXAMPLE 1

Example 1 describes a method for performing a service presented in FIGS. 1 and 3.

A payer makes shopping in a grocery. He/she decides to make the payment by his/her mobile phone MD operating within a system offered by a payment provider PSP. The payer is identified by the phone number MSISDN U_ID written in the phone SIM card. The payer, informs the merchant that he/she will pay with his/her phone. The merchant enters the transaction amount AMN onto a terminal POS and inserts a payment card issued by the payment provider PSP into the terminal. The data related to the transaction along with the terminal identifier POS_ID1 is sent to a clearing center ACH, from where, basing on the card number, an authorization request is sent to the payment provider PSP.

At the same time the payer calls the phone number shown at the terminal POS, the number being the identifier POS_ID2 of this terminal. The connection comprising the terminal identifier (the phone number POS_ID2 assigned thereto) and the payer identifier (his/her phone number U_ID) is sent to the payment provider PSP, which transmits back to the payer a detailed information about the transaction: what is the amount and to whom it is to be paid. Next, the payer accepts the transaction with a PIN code and the payment provider PSP sends an authorization request to the financial institution FI, being a bank hosting the payer's funds account. After receiving a permission for charging the account, the payment provider PSP sends the authorization confirmation to the terminal POS and the payer's phone via the clearing center ACH.

The clearing system discussed in the above example performs the following steps:

receives the authorization request, containing the terminal identifier POS_ID1, the transaction amount AMN, and the payment card data PCD from the payment card terminal POS via the clearing center ACH;
receives the authorization request containing the terminal identifier POS_ID2 being the phone number, the payer identifier U_ID being his/her mobile phone number from the mobile phone MD, and the transaction acceptance comprising the PIN code entered by the payer;
generates the final authorization request basing on the requests from the terminal POS and the mobile device MD, and sends it to the bank FI hosting the payer's funds account;
receives the message from the bank FI and sends the transaction confirmation to the payment card terminal POS;

### EXAMPLE 2

Example 1 describes a method for performing a service presented in FIGS. 2 and 4. A payer is going to pay for a dinner in restaurant. He/she uses his/her mobile device MD, this being a smartphone with an installed payment application. The waiter brings a bill, in which the terminal identifier POS_ID2 is printed. This identifier is unique for this particular payment transaction and it is not known to other payers. The payer logs in to the application on the smartphone MD giving his/her payer identifier U_ID and then he/she enters the terminal identifier POS_ID2. The data are sent from the smartphone MD to the payment provider PSP, which in turn sends the information to the payer about the restaurant in which he/she makes the payment. The payer accepts charging his/her account by the restaurant, optionally giving the maximum limit of the charging.

The waiter comes to the table with the terminal POS, enters the transaction amount AMN, inserts his card to the terminal reader and sends an authorization request including the payment card data PCD, the terminal identifier POS_ID1, and the transaction amount AMN to the clearing center ACH. The clearing center ACH sends the authorization request to the financial institution FI_2, which issued the payment card used by the merchant, while the financial institution FI_2 transmits this request to the payment provider PSP. The payment provider PSP checks whether the transaction amount AMN given by the merchant is within the payer defined limit, and having already the payer's pre-authorization, sends the authorization request to the financial institution FI hosting the payer's funds account. In the case of obtaining a permission for charging the payment account, a related confirmation is sent back to the payment terminal POS and the payer's smartphone MD.

The clearing system discussed in the above example performs the following steps:

receives the authorization request from smartphone MD, containing the terminal identifier POS_ID2 and the payer identifier U_ID entered by the payer in the smartphone MD as well as the pre-acceptance of the transaction;
receives the authorization request, containing the terminal identifier POS_ID1, the transaction amount AMN, and the payment card data PCD, from the payment card terminal POS, via the clearing center ACH;
generates the final authorization request basing on the requests from the terminal POS and the smartphone MD, and sends it to the bank FI hosting the payer's funds account;
receives the message from the financial institution FI and sends the transaction confirmation to the payment card terminal POS.

### EXAMPLE 3

A payer makes a payment in a store using a mobile device MD connected to a WiFi network. The merchant enters, in a payment card terminal POS, data of a payment card dedicated to the service, and then the terminal POS sends an authorization request to the clearing center ACH. The clearing center ACH checks whether it has the payer's pre-authorization for the transaction and, if not, it sends, to the payment provider PSP, the information about the transaction coming from the terminal POS. The payer logs in to the application in his/her mobile device MD giving his/her payer identifier U_ID and enters the terminal identifier POS_ID2. The data is sent to the payment provider PSP that sends back the information about the transaction, asking the payer for the authorization thereof. The payer's authorization is sent to the payment provider PSP, and then to the clearing center ACH that generates the final authorization request and sends it to the financial institution FI hosting the payer's funds account. After receiving the authorization from the financial institution FI, a confirmation is sent to the terminal POS.

The advantage of the proposed solution is the lack of any modification on the side of the card terminals and, in consequence, practically zero investment costs and much easier and cheaper maintenance of the service. Also, the lack of the necessity of modifying the card terminal allows for much faster and simpler implementing of the service, and so, its faster adaptation on the market.

1. A method for authorizing payments with the use of a mobile device (MD) by a payer and a payment card terminal (POS) by a merchant, terminal identifiers (POS_ID1, POS_ID2) being assigned to the payment card terminal (POS), while a payer identifier (U_ID) being assigned to the payer, the method comprising the steps of:
entering the amount of the transaction (AMN) into the terminal (POS);
entering payment card data (PCD), the card being issued by a payment provider (PSP), into the terminal;
sending the terminal identifier (POS_ID1), the payment card data (PCD), and the transaction amount (AMN) from the terminal (POS) to the clearing center (ACH);
recognizing, by the clearing center (ACH), basing on the payment card data (PCD), that the transaction with the entered payment card is a transaction with the use of a mobile device (MD);
sending, by the clearing center (ACH), an authorization request to the payment provider (PSP);
entering, on the mobile device (MD), the terminal identifier (POS_ID2) and the payer identifier (U_ID);
sending the terminal identifier (POS_ID2) and the payer identifier (U_ID) from the mobile device (MD) to the payment provider (PSP);
sending, by the payment provider (PSP), the data related to the currently possessed transaction to the mobile device (MD);
accepting ACK, by the payer, the transaction on the mobile device (MD) and sending the transaction acceptance (ACK) to the payment provider (PSP).

2. A method according to claim 1, further comprising:
sending an authorization request from the payment provider (PSP) to a financial institution (FI) hosting the payer's funds account, and
sending the transaction confirmation to the terminal (POS).

3. A method according to claim 2, also comprising:
sending the confirmation to the mobile device (MD).

4. A method according to claim 1, wherein the payer identifier (U_ID) is assigned to the mobile device (MD) or the information carrier attached to this device, and is read out automatically from the mobile device (MD) or the information carrier.

5. A method according to claim 1, wherein the authorization request to the financial institution (FI) is sent from the clearing center (ACH).

6. A method according to claim 1, wherein the authorization request is sent from the clearing center (ACH) to financial institution (FI_2) collaborating with the payment provider (PSP), the financial institution forwarding the request to the payment provider (PSP).

7. A clearing system for authorizing payment transactions, comprising: an IT system adapted for:
receiving an authorization request from a payment card terminal (POS) via a clearing center (ACH),
receiving an authorization request from a mobile device (MD),
generating, basing on the requests from the terminal (POS) and mobile device (MD), a final authorization request, and sending it to a financial institution (FI).

8. A clearing system according to claim 7, adapted for receiving a message from the financial institution (FI) and sending the information contained therein to the terminal (POS).

9. A clearing system according to claim 8 adapted for sending the information contained in the message from the financial institution (FI) to the mobile device (MD).
